(19) United States
(12) Patent Application Publication
(10) Pub. No.: US 2012/0191250 A1
(43) Pub. Date: Jul. 26, 2012

(54) POWER TOOL

(75) Inventors: Kazutaka Iwata, Ibaraki (JP); Nobuhiro Takano, Ibaraki (JP); Hideyuki Tanimoto, Ibaraki (JP); Yukihiro Shima, Ibaraki (JP)

(73) Assignee: HITACHI KOKI CO., LTD.,, Tokyo (JP)

(21) Appl. No.: 13/383,207

(22) PCT Filed: Jul. 6, 2010
(86) PCT No.: PCT/JP2010/061738

§ 371 Date: Apr. 10, 2012

(30) Foreign Application Priority Data
Jul. 10, 2009 (JP) 2009-163941

(51) Int. Cl. G05B 13/00

(52) U.S. Cl. 700/275

(57) ABSTRACT

According to an aspect of the present invention, there is provided a power tool including: a motor; a driving circuit that supplies an electric power from a power supply to the motor; a control part that sets a target rotation number for the motor in accordance with a mode selected from a plurality of modes, each mode having a corresponding target rotation number; and a voltage detecting circuit that detects a voltage of the power supply, wherein the target rotation number is varied based on the detected voltage.

### TECHNICAL FIELD

An aspect of the present invention relates a power tool in which the rotation of a motor is controlled.

### BACKGROUND ART

In a screw fastening power tool such as a driver drill, a given rotation number is previously selected from plural available rotation numbers of a motor, and the screw fastening work is performed by rotating the motor at the selected rotation number. For example, JP-H09-065675-A discloses method for controlling the motor. The rotation number may be selected, for example, by rotating a mode selecting dial, or by pressing a tact switch, at given times. By enabling plural rotation numbers of the motor to be selected, it is possible to efficiently perform extensive works from a low loaded work to a high loaded work. When performing the screw fastening work or the like, it is important to cause the motor to follow the user's operation of a trigger, and to not cause interruption of the motor during the work, from start of the trigger operation until release of the trigger operation.

FIG. 14 illustrates characteristics of a motor in a comparison-example power tool, in which relation between the rotation number of the motor and generated torque, and target rotation numbers in respective velocity modes are shown. This is the characteristics of the motor when a power supply is fully supplied (a battery is fully charged) , and the rotation number of the motor when it is not loaded is N₀ (rpm) . As the load exerted on the motor is increased, the rotation number of the motor is decreased in inverse proportion, and the rotation number is decreased to zero at the torque T₀. In the power tool employing the motor having such characteristics, the three target rotation numbers, for example, are set in respective modes of the rotation number. In case where the target rotation numbers are set, a control part of the power tool controls the motor by using a given control system (for example, PID control system) so that the motor rotates at the target rotation number.

FIG. 15 illustrates a control of the rotation of motor through the PID control system. In FIG. 15, a Y-axis represents the rotation number (rpm) of the motor or a PWM duty (%) of a switching element for actuating the motor. The motor is actuated at a time 0, and a duty ratio in a pulse width of a PWM driving signal (hereinafter, referred to as a “PWM duty”) is increased to 100%, as shown by an arrow mark c1. This is because there is a large difference between the target rotation number and an actual rotation number, and hence, when the PID control is performed in this region, a feedback control is applied so as to increase the PWM duty. Following this control, the rotation number of the motor is increased as shown by an arrow mark b1. As shown by an arrow mark c2, the difference between the target rotation number and the actual rotation number becomes smaller, and hence, a feedback control is applied so as to decrease the PWM duty. As a result, the motor is controlled at a constant speed of the target rotation number Nt. In case where the motor is rotated at a constant speed of the target rotation number Nt, the PWM duty is maintained at a given value, as shown by an arrow mark c3.

In case where the load exerted on the motor is increased for some reason, as shown by an arrow mark b3 in FIG. 15, the rotation number of the motor is temporarily decreased from the target rotation number, as shown by an arrow mark b4. On this occasion, there occurs a difference between the target rotation number and the actual rotation number, and hence, the motor is controlled by the PID control so as to increase the PWM duty as shown by an arrow mark c4. Thereafter, the motor is driven with the increased load, at the PWM duty for rotating the motor at the target rotation number, as shown by an arrow mark c5, and the motor is rotated at a constant speed of the target rotation number, as shown by arrow marks b5 and b6.

FIG. 5 illustrates relation between the target rotation numbers in respective modes and a motor characteristic m3, when a remaining power of a battery pack 30 is decreased. As understood from this graph, when the remaining power of the battery is decreased, the motor characteristic m3 intersects none of the target rotation numbers in Modes 1 to 3. Therefore, it becomes impossible to rotate the motor at any of the target rotation numbers in Modes 1 to 3. For this reason, there occurs such inconvenience that it becomes impossible to control the rotation number, and workability is deteriorated, even though the user intentionally converts the velocity mode.

### SUMMARY OF INVENTION

One object of the invention is to provide a power tool in which a motor can be stably rotated according to a preset target rotation number.

It is another object of the invention to provide a power tool in which unstable operation of the motor due to a voltage drop in a battery pack can be avoided.

It is still another object of the invention to provide a power tool in which a constant-speed control can be accurately performed during the rotation of the motor so as to attain the target rotation number.

According to an aspect of the present invention, there is provided a power tool including: a motor; a driving circuit that supplies an electric power from a power supply to the motor; a control part that sets a target rotation number for the motor in accordance with a mode selected from a plurality of modes, each mode having a corresponding target rotation number; and a voltage detecting circuit that detects a voltage of the power supply, wherein the target rotation number is varied based on the detected voltage. The power tool may further includes a switch trigger to activate the motor. The control part may measure the voltage after the switch trigger is turned on and before the motor starts to rotate, and may set the target rotation number based on the measured voltage.

The power tool may further includes: a selecting switch to select between the plurality of modes. The control part may measure the voltage when the mode is changed by the selecting switch. The target rotation number may be set to be proportional to the voltage of the power supply. The motor may be a brushless DC motor.

The driving circuit may be an inverter circuit including a semiconductor switching element. The control part may control a PWM duty which is supplied to the inverter circuit, thereby to control the rotation of the motor. The control part may control the PWM duty by performing a PID control, thereby to bring the rotation number of the motor to the target rotation number. The control part may change a gain of the PID control based on the measured voltage. The gain may be increased or decreased in proportion to the voltage of the power supply.

According to a first aspect of the invention, the power tool is provided with the voltage detecting circuit for detecting the voltage of the power supply while the motor is stopped, and the target rotation number is changeably set based on the detected voltage. Therefore, it is possible to appropriately change the target rotation number, even though the power supply voltage varies.

According to a second aspect of the invention, the voltage of the power supply is measured before the motor starts to rotate, and the target rotation number is set based on the measured voltage. Therefore, it is possible to set the optimal target rotation number corresponding to the power supply voltage, before starting each work.

According to a third aspect of the invention, the control part measures the voltage of the power supply when the target rotation number is changed by the selecting switch, and sets the target rotation number based on the measured voltage. Therefore, the target rotation number is not changed unless the selecting switch is operated. As a result, scattering of the rotation numbers does not occur, and the work can be constantly performed.

According to a fourth aspect of the invention, the target rotation number is so set as to be increased or decreased in proportion to the power supply voltage. Therefore, it is possible to appropriately change the target rotation number, even though the power supply voltage varies.

According to a fifth aspect of the invention, the control part controls the PWM duty which is supplied to the inverter circuit, thereby to control the rotation of the motor. Therefore, it is possible to control the rotation of the motor with high efficiency and high accuracy.

According to a sixth aspect of the invention, the control part controls the PWM duty by the PID control, whereby constant-speed control is performed so that the rotation number of the motor may reach the target rotation number, and accurate control of the rotation of the motor can be performed. Moreover, even in case where the rotation of the motor is disturbed due to variation of the load, it is possible to instantly recover the target rotation number.

According to a seventh aspect of the invention, the control part changes a gain of the PID control based on the measured voltage, and hence, it is possible to enhance controlling performance of the PID control.

According to an eighth aspect of the invention, the control gain to be changed is increased in inverse proportion to the power supply voltage. When the power supply voltage is relatively low, the feedback gain is increased and following performance to the target rotation number is maintained, and when the power supply voltage is relatively high, the feedback gain is decreased, and occurrence of overshoot is restrained. In this manner, the control at the constant rotation number can be accurately performed irrespective of the power supply voltage.

According to a ninth aspect of the invention, the motor to be used is a brushless DC motor. Therefore, highly accurate control of the rotation can be performed, and the power tool having high efficiency and requiring less electric power can be realized.

The above described objects, other objects, and additional features of the invention will be made apparent from the following description and drawings.

### BRIEF DESCRIPTION OF DRAWINGS

FIG. 1 illustrates a power tool according to an embodiment, a part of which being shown in section.

FIG. 2 sectionally illustrates a motor 2 in FIG. 1.

FIG. 3 illustrates a functional block diagram of the power tool according to the embodiment.

FIG. 4 illustrates relation between rotation number of the motor and output torque.

FIG. 5 illustrates relation between the rotation number of the motor and the output torque, when power supply voltage drops.

FIG. 6 illustrates relation between the power supply voltage of the motor and target rotation numbers in respective modes.

FIG. 7 illustrates relation between the rotation number of the motor and the output torque, when the power supply voltage drops.

FIG. 8 illustrates a control process flow for the motor according to the embodiment.

FIG. 9 illustrates the change in the target rotation number when the velocity mode of the motor is converted according to the embodiment.

FIG. 10 illustrates a control process flow for the motor in a second embodiment.

FIG. 11 illustrates relation between the rotation number of the motor and electric current of the motor, in case of control with a fixed PWM duty and in case of PID control.

FIG. 12 illustrates relation between various gains to be used in the PID control and the power supply voltage.

FIG. 13 illustrates a control process flow for the motor in a third embodiment.

FIG. 14 illustrates relation between rotation number of a motor and electric current, in case of control with a fixed PWM duty and in case of constant-speed control, in a comparison-example case.

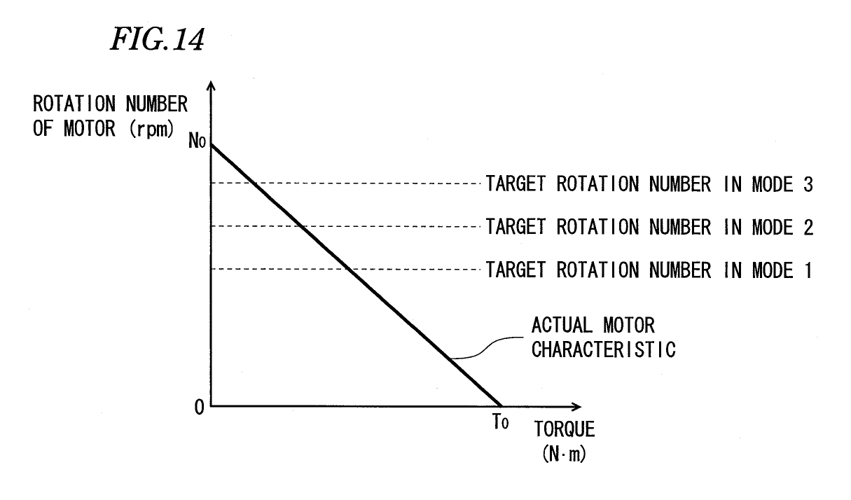

FIG. 15 illustrates relation between the rotation number and the PWM duty in the constant-speed control method of the motor and time, in the comparison-example case.

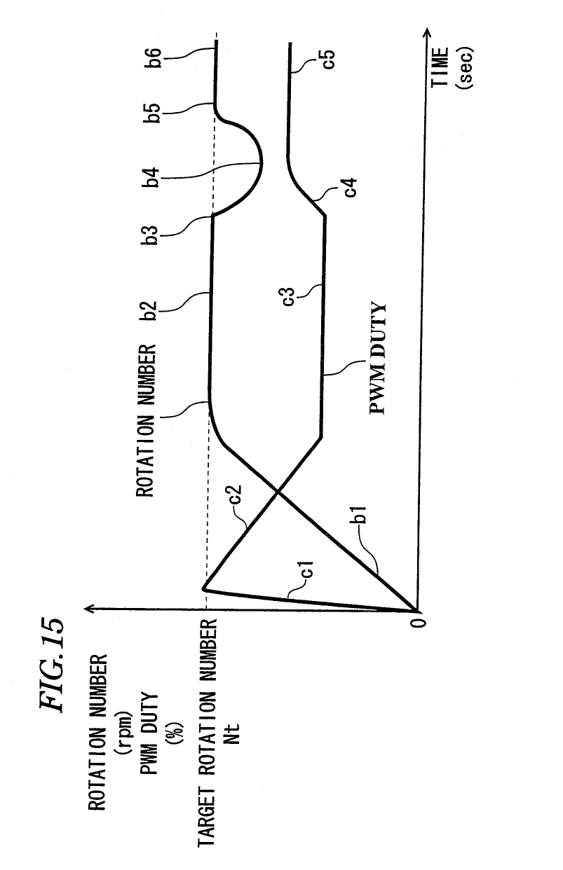

### DESCRIPTION OF EMBODIMENTS

### Embodiment 1

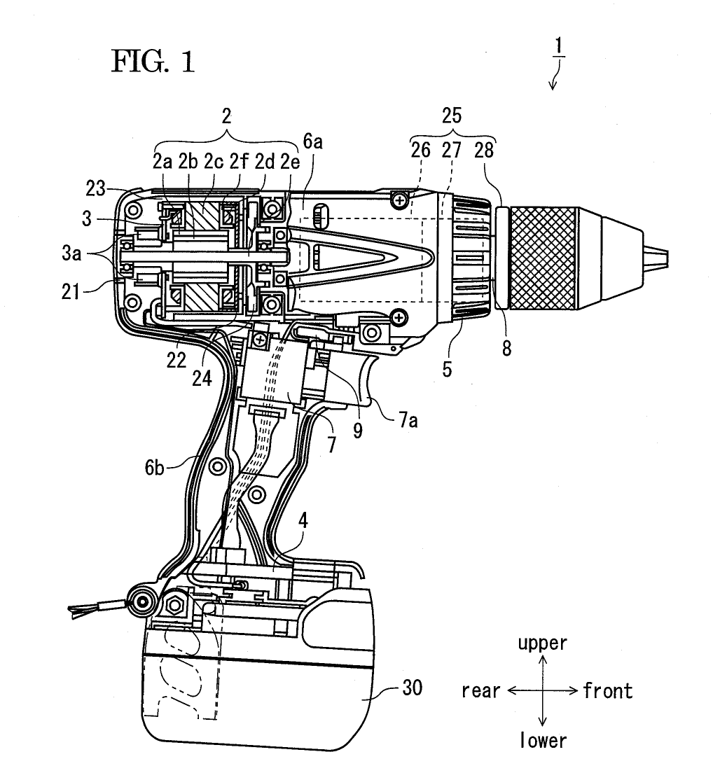

Now, an embodiment will be described in detail, referring to the drawings. In this specification, upper, lower, front and rear directions respectively correspond to those directions as shown in FIG. 1. FIG. 1 illustrates a power tool according to an embodiment, a part of which being shown in section. Although a driver drill 1 is exemplified in this embodiment, the invention is not limited thereto, and may be applicable to other power tools such as an impact driver, a hammer drill.

In FIG. 1, a driver drill 1 includes a motor 2 in a barrel housing part 6a, and rotates a tip tool (not shown) such as a driver and a drill to be detachably attached to a chuck 28 mounted on a spindle (an output shaft) 8, through a power transmitting part 25 for transmitting a driving power of the motor 2. An inverter circuit part (a circuit board) 3 for driving the motor 2 is housed in a rear part of the barrel housing part 6a. The barrel housing 6a houses, in an intermediate part and at a front side thereof, a reduction mechanism part 26 for transmitting a rotation power from a rotation shaft 2e of the motor 2 frontward while reducing the rotation number, and a clutch mechanism part 27 for transmitting a rotation torque obtained on the output shaft of the reduction mechanism part 26 to the spindle 8. The clutch mechanism part 27 is coupled to the reduction mechanism part 26 so as to transmit the rotation power of the reduction mechanism part 26 to the spindle (the output shaft) 8. An ordinary impact mechanism may be provided instead of this clutch mechanism part 27.

The clutch mechanism part 27 has a dial (a clutch dial) 5 for allowing the user to select between a driver mode and a drill mode and to adjust the torque. When the driver mode is selected, by rotating the dial 5 to a given rotation angle among plural steps (for example, ten steps), the rotation torque which is transmitted from the reduction mechanism part 26 to the spindle 8 can be adjusted by the clutch mechanism part 27 to a desired fixing torque corresponding to a load. When the load exceeding the set fixing torque (a starting torque) is applied to the spindle 8 in this driver mode, the output shaft of the reduction mechanism part 26 is disconnected from the spindle 8 by the clutch mechanism 27 of the power transmitting part 25, and idly rotates. In this manner, the motor 2 is prevented from being locked.

When the drill mode is selected, the maximum rotation power obtained in the reduction mechanism part 26 when rotating the dial 5 to the largest rotation angle to the spindle 8 without operating the clutch. When the load exceeding the fixing torque is applied to spindle 8 in this drill mode, since the clutch does not work, the tip tool held by the spindle 8 is locked, because and the motor 2 is comes into a locked state. The reduction mechanism part 26 is constructed by known art, and includes, for example, a planet gear reduction mechanism of two steps (a change gear case) (not shown) to be engaged with a pinion gear which is provided at a front end of the rotation shaft 2e of the motor 2.

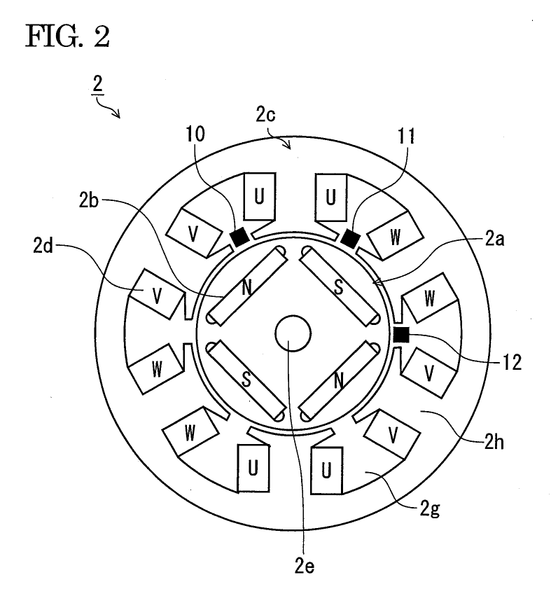

In this embodiment, a three phase brushless DC motor is used as the motor 2. FIG. 2 sectionally illustrates the motor 2 in FIG. 1. This sectional plane is taken along a plane perpendicular to the output rotation shaft of the motor 2. As shown in FIG. 2, the motor 2 includes a rotor 2a and stator windings (armature windings) 2d. The motor is a so-called interior permanent magnet motor in which the rotor 2a has permanent magnets (magnet) 2b having SN-poles extending in a direction of the rotation shaft 2e, and the cylindrical-shaped stator 2c has the stator windings 2d which are wound around a teeth part 2h within a slot 2g.

The stator windings 2d are wound around the stator 2c through resin insulating layers 2f (See FIG. 1). Three Hall ICs (rotation position detecting elements) 10 to 12 for detecting the position of the rotor 2a by inductive coupling are arranged near the rotor 2a, with intervals of 60 degrees in a circumferential direction. Electric currents which are controlled to electric angle of 120° according to position detecting signals from the Hall ICs 10 to 20 are supplied from the inverter circuit part 3 to the star-connected stator windings 2d (U phase, V phase, and W phase). To detect the rotation position, there may be used a sensorless method in which the rotation position of the rotor is detected, by extracting inductive electromotive voltage (back electromotive force) of the stator windings 2d as a logical signal, through a filter.

Referring to FIG. 1, the barrel housing part 6a and a handle housing part 6b are integrally molded by use of synthetic resin material. The barrel housing part 6a and the handle housing part 6b are splittable at a vertical plane passing through the rotation shaft 2e of the motor 2. For assembling, a pair of housing members (a left or a right side part of the barrel housing part 6a and the handle housing part 6b) are prepared, and the stator 2c and the rotor 2a of the motor 2 are incorporated, in advance, into one of the housing members, as sectionally shown in FIG. 1. Thereafter, the other housing member is superposed thereon, and the two housing members are fastened by screwing or the like. Plural stator holding parts (rib parts, not shown) are integrally formed on an inner wall of the barrel housing part which is opposed to an outer peripheral face of the stator 2c, and the motor 2 is grasped or clamped by the stator holding parts.

A cooling fan 24 is coaxially provided at a distal end side of the motor 2, and an exhaust hole (a ventilating hole, not shown) is formed in the barrel housing part 6a near the cooling fan 24. An air intake hole (a ventilating hole) 21 is formed at a back end of the barrel housing part 6a. A passage 23 from this air intake hole 21 to the exhaust hole which is formed near the cooling fan 24 is formed as a passage of cooling air, and suppresses a temperature rise of a semiconductor switching element 3a of the inverter circuit part 3 and a temperature rise of the stator windings 2d of the motor 2. In the driver mode or in the drill mode, a large current may flow to the switching element 3a depending on a loaded state of the motor 2, and heat generation of the switching element 3a is increased. Therefore, it is important to forcibly cool the inverter circuit part 3 with the cooling fan 24.

The inverter circuit part 3 has a disc-like-shaped circuit board and covers one end side (a rear side) of the stator 2c of the motor 2. On the other hand, a dustproof cover 22 is provided to cover the other end side (a front side) of the stator 2c in the same manner as the inverter circuit part 3. Both the inverter circuit part 3 and the dustproof cover 22 form a dustproof structure (a tight sealing structure) for closing or tightly sealing the rotor 2a together with the stator 2c, so that intrusion of dust into the motor 2 can be prevented.

A battery pack 30 as a power supply for driving the motor 2 is detachably mounted to a lower end part of the handle housing part 6b. A control circuit board 4 including a control part 31 for controlling the rotation of the motor 2 is provided above the battery pack 30 so as to extend in a longitudinal direction and in a lateral direction.

A switch trigger 7 is disposed near an upper end of the handle housing part 6b, and urged so that a trigger operating part 7a thereof is projected from the handle housing part 6b. When the user pushes the trigger operating part 7a, the rotation number of the motor 2 is controlled based on the pushing amount (operating amount). In this embodiment, the pushing amount of the switch trigger 7 is reflected on the PWM duty of the PWM driving signal for activating the semiconductor switching element 3a of the inverter circuit part 3.

The battery pack 30 is electrically connected to the switch trigger 7 and the control circuit board 4 for supplying the driving power, and further, electrically connected to the inverter circuit part 3 for supplying the driving power. A secondary battery such as a lithium ion battery, a nickel cadmium battery or a nickel hydride battery is used as the battery pack 30. The lithium ion battery has three times as large as energy density as compared with the nickel cadmium battery and the nickel hydride battery, and is compact and lightweight. An output voltage of this battery pack 30 is 18.0 V, for example.

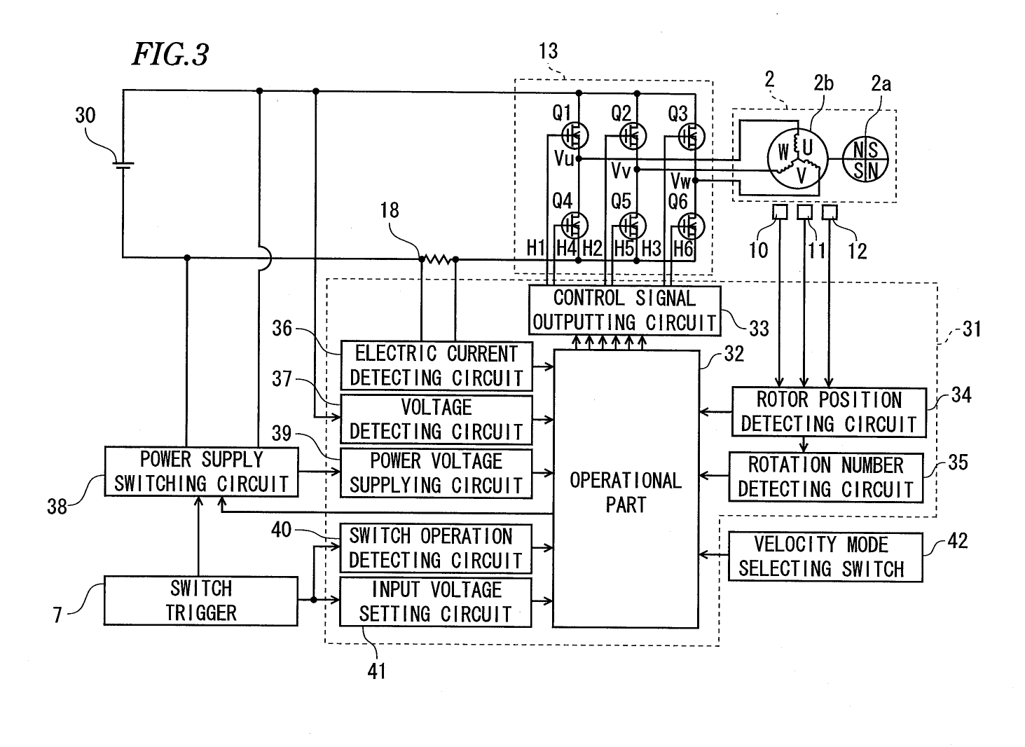

Now, referring to FIG. 3, a functional block diagram of the power tool according to the embodiment is shown. An inverter circuit 13 is mounted on the inverter circuit part 3, and includes six switching elements Q1 to Q6 connected into three phase bridges. Although insulating gate bipolar transistors (IGBT) are used as the switching elements Q1 to Q6, in this embodiment, field-effect transistors (MOSFET) or bipolar transistors maybe used. The control part 31 includes a control signal outputting circuit 33, and respective gates of the bridge-connected six switching elements Q1 to Q6 are connected to the control signal outputting circuit 33. Collectors or emitters of the six switching elements Q1 to Q6 are connected to the star-connected stator windings 2d (the windings U, V, W). In this manner, the six switching elements Q1 to Q6 perform switching operations by PWM driving signals H1 to H6 inputted from the control signal outputting circuit 33, whereby the DC voltage of the battery pack 30 inputted to the inverter circuit 13 is converted to driving voltages Vu, Vv, Vw in the three phases (the U phase, V phase, W phase), and the AC voltages in three phases are supplied to the stator windings 2d (the three phase windings U, V, W).

In FIG. 3, the control part 31 includes various types of circuits mounted on the control circuit board 4 (See FIG. 1). An operational part 32 controls all the functions of the driver drill 1 including control of the rotation of the motor 2. The operational part 32 includes, although not shown, a CPU for outputting driving signals according to programs and data, a ROM for storing the programs and the data for performing a control process as described below, a RAM for temporarily storing the data, and a microcomputer including a timer for counting time, and performs the various processes based on the programs and data. A rotor position detecting circuit 34 detects a rotation position of the rotor 2a based on output signals from the Hall ICs 10 to 12, and outputs position data of the rotor 2a to the operational part 32. A rotation number detecting circuit 35 detects the rotation number of the motor 2 from a time interval of the signals which are outputted from the Hall ICs 10 to 12.

A power supply switching circuit 38 is a main switch for supplying power into the control part 31. By turning on the power supply switching circuit 38, the power from the battery pack 30 is supplied to a power voltage supplying circuit 39. The power voltage supplying circuit 39 may be manually on-off controlled by the switch trigger 7 or controlled in accordance with a control signal from the operational part 32. For this purpose, a control signal line is connected from the operational part 32 to the power supply switching circuit 38. The power voltage supplying circuit 39 converts the voltage supplied from the battery pack 30 to a given voltage (for example, 5V) to be used in the control part 31, and supplies the voltage to the operational part 32 and other electric circuits (not shown).

An electric current detecting circuit 36 detects the driving current of the motor 2 through a shunt resister 18, and outputs the detected driving current to the operational part 32. A voltage detecting circuit 37 measures the voltage supplied from the battery pack 30, and outputs the measured voltage to the operational part 32. A switch operation detecting circuit 40 judges whether or not the trigger operating part 7a of the switch trigger 7 is operated, and outputs the result to the operational part 32. In response to the pushing amount of the switch trigger 7, an input voltage setting circuit 41 sets the PWM duty of the PWM signal corresponding to an output control signal which is generated in the switch trigger 7 . Although not shown in FIG. 3, a circuit for setting the rotation direction of the motor 2 is further provided, whereby operation of a reversing lever 9 (See FIG. 1) indicating normal rotation direction or reverse rotation direction is detected, and the result is outputted to the operational part 32.

The operational part 32 generates the output driving signal to the control signal outputting circuit 33, based on the information outputted from the electric current detecting circuit 36, the voltage detecting circuit 37, the switch operation detecting circuit 40, and the input voltage setting circuit 41, and controls the input voltages Vu, Vv, Vw to the motor 2, by controlling the PWM duty of the PWM driving signals from the switching elements Q1 to Q6. On this occasion, the motor 2 is rotated at the target rotation number set by a velocity mode selecting switch 42. Moreover, the given switching elements Q1 to Q6 are switched in a given order, based on the information of a rotation direction setting circuit (not shown), and the rotor position detecting circuit 34, thereby to control so that the input voltages Vu, Vv, Vw may be supplied to the stator windings U, V, Win a given order. In this manner, the motor 2 is controlled to rotate in the rotation direction set by the reversing lever 9.

The operational part 32 supplies the PWM driving signals H4, H5, H6 of the three switching elements Q4, Q5, Q6 at a minus power side, among the switching driving signals (three phase signals) for driving the respective gates of the six switching elements Q1 to Q6, and adjusts the electric power to the motor 2, by varying a pulse-width duty ratio (PWM duty) of the PWM driving signal, based on an output signal of the input voltage setting circuit 41 corresponding to the pushing amount of the switch trigger 7 (See FIG. 1), thereby to control actuation of the motor 2 and the rotation speed. Instead of supplying the PWM driving signal to the three switching elements Q4, Q5, Q6 at the minus power side, the driving signals H1 to H3 of the switching elements Q1, Q2, Q3 at a plus power side may be formed as the PWM driving signals. As a result, it is possible to control the input voltage which is supplied from the DC voltage of the battery pack 30 to the respective stator windings U, V, W.

Moreover, the operational part 32 short-circuits the stator windings, by turning on the three switching elements Q4, Q5, Q6 at the minus power side and turning off the three switching elements Q1, Q2, Q3 at the plus power side, thereby to form a passage for flowing the electric current in braking operation. In this manner, a kinetic energy during the rotation of the motor is converted to an electric energy, and braking operation is performed by short-circuit.

According to the above described structure, the control part 31 outputs the PWM driving signals H1 to H6 from the control signal outputting circuit 33 to the inverter circuit 13, and alternately controls switching of the switching elements Q1 to Q6, thereby to supply the three-phase AC voltage to the stator windings U, V, W of the motor 2. Moreover, the control part 31 controls the electric current and the rotation number (rotation speed) of the motor 2, by adjusting the PWM duty of the PWM driving signals H1 to H6.

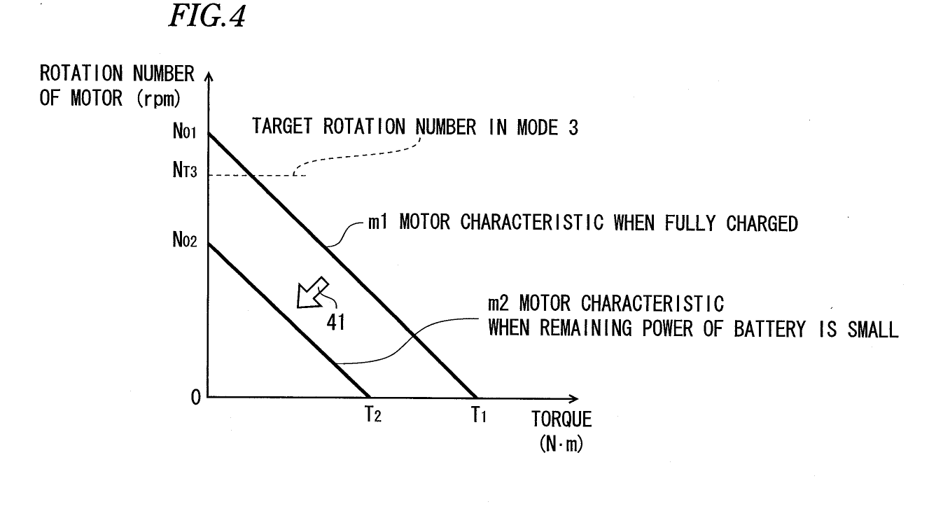

Referring to FIG. 4, relation between the rotation number of the motor and the generated torque relative to a drop in the power supply voltage will be described. FIG. 4 illustrates relation between the rotation number of the motor and the load applied to the motor, in which the rotation number (rpm) is shown on a Y-axis, and the torque of the load (N.m) is shown on an X-axis. When the power supply voltage of the battery pack drops, the rotation number of the motor is decreased according to the drop. Provided that the rotation number is N01, when the motor 2 is not loaded in a state where the battery pack 30 (power supply voltage) is fully charged, the maximum fixing torque is T1, and the relation between the rotation number and the generated torque is shown by a motor characteristic m1 in a rectilinear shape. This motor characteristic m1 moves to the motor characteristic m2 in parallel as indicated by an arrow mark 41, as the remaining power of the battery pack 30 decreases. In case where the battery pack 30 where the voltage drops is used, the rotation number of the motor in an unloaded state is N02, and the maximum fixing torque becomes T2. For example, when “the target rotation number in Mode 3” is Nt3, it is impossible to rotate the motor 2 at the target rotation number Nt3, with the battery pack 30 in which the remaining power is decreased.

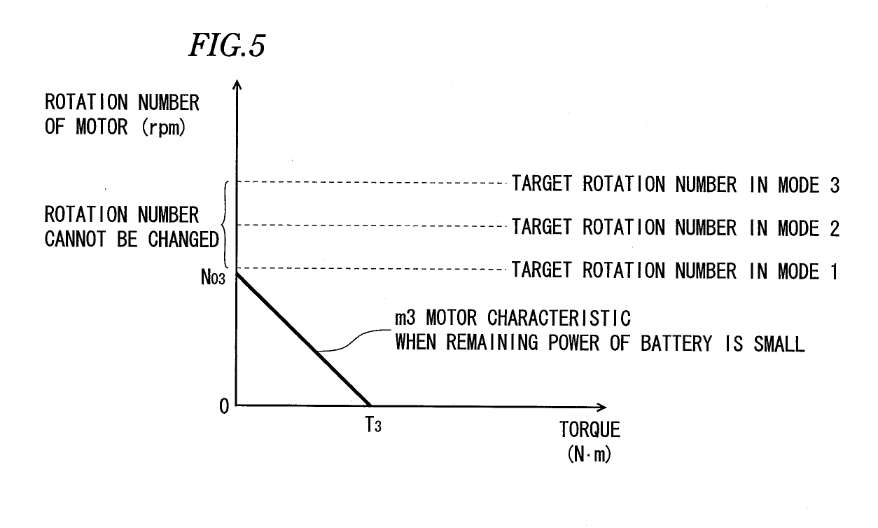

FIG. 5 illustrates relation between the target rotation numbers in the respective modes and the motor characteristic m3, when the remaining power of the battery pack 30 is decreased. As understood from this graph, when the remaining power is decreased, the motor characteristic m3 does not intersect any of the target rotation numbers in Modes 1 to 3. Therefore, it is impossible to rotate the motor at any of the target rotation numbers in Modes 1 to 3. For this reason, the rotation number cannot be changed, even though the user converts the velocity mode.

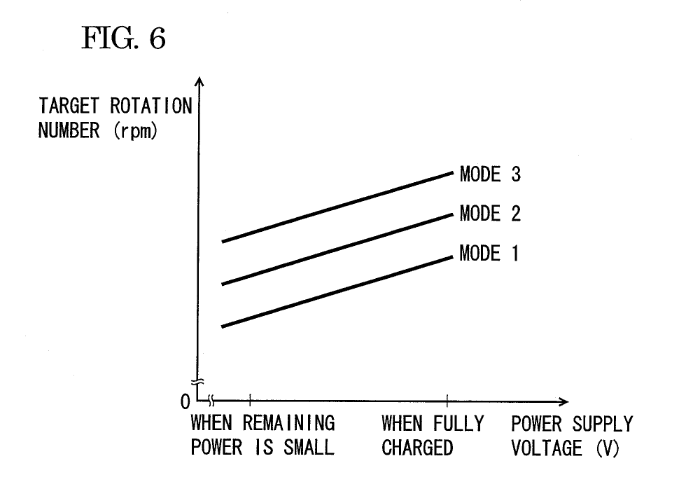

In this embodiment, the target rotation numbers in the respective modes are varied in accordance with the power supply voltage, as shown in FIG. 6, it is possible to appropriately convert stepwise the velocity modes, even though the power supply voltage varies. An object of the constant-speed control of the power tool is to prevent decrease of the rotation number in a highly loaded state, thereby to enhance workability, and to finely control conversion of the velocity modes according to the work. In this embodiment, the velocity modes can be converted even in case where the power supply voltage drops. Degree of reducing the rotation speed with respect to the drop in the power supply voltage may be set according to performances of the motor and the power tool, and an object for use. For example, for the battery pack 30 specified at 18.0V, when the target rotation numbers of Modes 1, 2, 3 in a fully charged state (21.0V) are respectively 14000 rpm, 17500 rpm, and 21000 rpm, the target rotation numbers of Modes 1, 2, 3 in a dropped state (16.0V) may be respectively at 10666 rpm, 13333 rpm, and 16000 rpm.

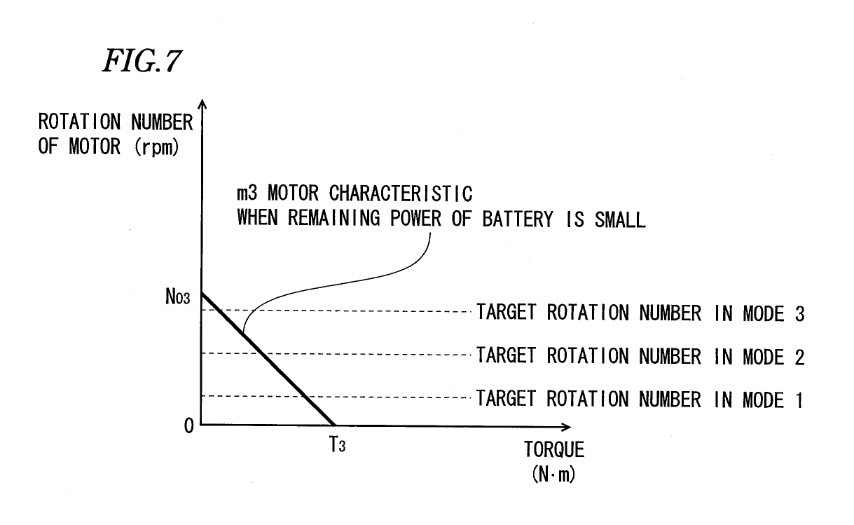

FIG. 7 illustrates relation between the target rotation numbers in the respective modes and the motor characteristic m3, when the remaining power of the battery pack 30 is small. As understood from this graph, when the remaining power is decreased, the motor characteristic m3 intersects all the target rotation numbers in Modes 1 to 3, and therefore, it is possible to rotate the motor at the preset target rotation number. In this manner, it is possible to change the target rotation number, by converting the velocity modes according to the remaining power of the battery voltage. As a result, such inconvenience that the rotation number cannot be changed with the variation of the power supply voltage is eliminated, and it is possible to appropriately change the rotation number according to the work.

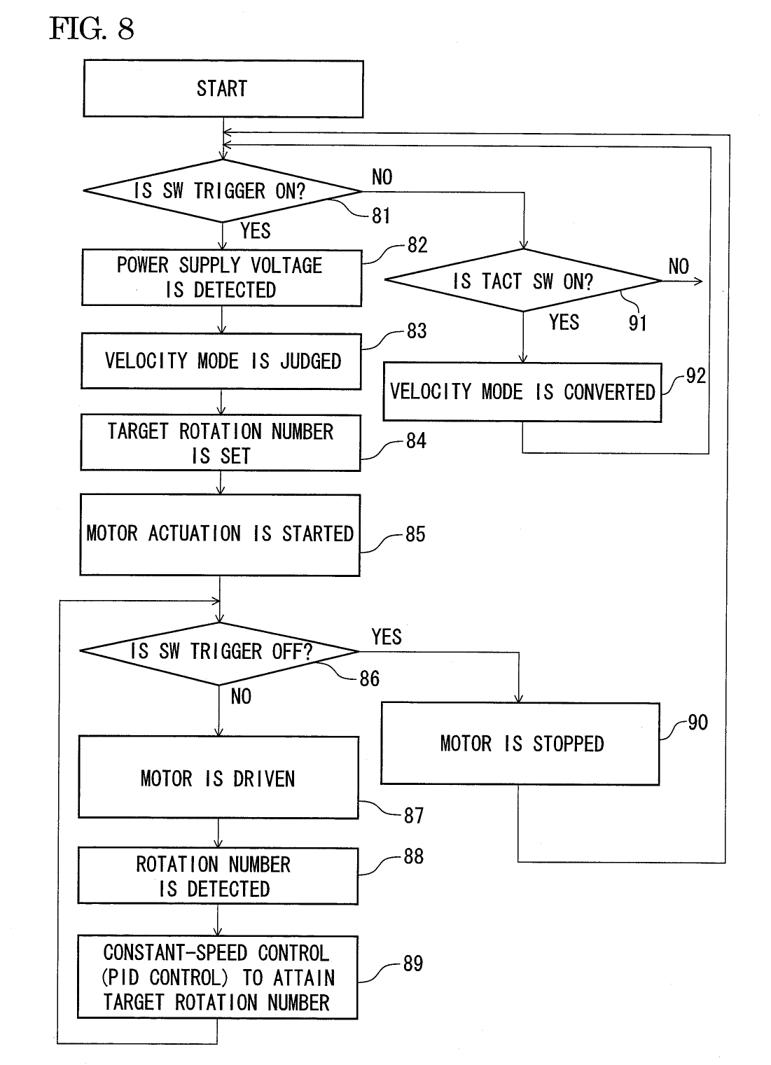

Then, a control process flow for the motor according to the embodiment will be described, referring to FIG. 8. As a first step, whether or not the switch trigger 7 is turned on is judged in Step 81. In case where the switch trigger 7 is kept off, whether or not a tact switch (not shown) as the velocity mode selecting switch 42 is turned on is judged (Step 91). In case where the tact switch is turned on, the velocity mode of the motor 2 is converted (Step 92). In case where the tact switch is not turned on, the process is returned to Step 81 (Step 91).

In case where the switch trigger 7 is turned on in Step 81, a signal to that effect is transmitted to the power supply switching circuit 38, and the power supply switching circuit 38 supplies the voltage from the battery pack 30 to the power voltage supplying circuit 39. The power voltage supplying circuit 39 generates the power supply voltage required for the respective elements in the control part 31 (for example, DC voltage of 5V) from the voltage of the battery pack 30, and supplies this power supply voltage to the elements in the operational part 32 and so on. By supplying this power supply voltage, the power of the control part 31 including the operational part 32 is turned on.

Then, in response to an output from the voltage detecting circuit 37, the operational part 32 detects the voltage of the battery pack 30 (Step 82). This is the voltage at a time immediately before the motor 2 is started to rotate, and the power supply voltage at a time when the motor 2 is stopped. Then, the operational part 32 judges the set velocity mode of the motor 2 (Step 83). The velocity mode is maintained in the initial state unless it is converted, and the previously-set velocity mode is maintained as long as the user does not convert the velocity mode before pressing the trigger switch. Then, the operational part 32 sets the target rotation number from the relation as shown in FIG. 6, based on the voltage detected by the voltage detecting circuit 37 (Step 84). In order to set this target rotation number, the relation as shown in FIG. 6 may be previously stored in a memory as a formula or a data table. When the target rotation number is set, the operational part 32 actuates the motor 2, and accelerates the rotation of the motor 2 up to the preset target rotation number. The actuation of the motor 2 can be controlled by the known PWM control, and detailed description will be omitted. Since the time required for the processes from Step 81 to Step 85 is very short, less than a few milliseconds, the user operating the switch trigger 7 will not recognize a time lag.

Then, whether or not the switch trigger 7 is turned off is detected (Step 86). In case where it is turned off, this means finish or stop of the work. Therefore, the operational part 32 transmits a control signal to the control signal outputting circuit 33 so that the driving power is not supplied to the motor 2, thereby stopping the motor. Then, the process is returned to Step 81 (Step 90). In case where the trigger is kept on in Step 86, the driving control of the motor is continued (Step 87), and the operational part 32 detects the rotation number of the motor 2 using the rotation number detecting circuit 35 (Step 88). Then, the operational part 32 obtains a deviation between the detected rotation number and the target rotation number, and performs a feedback control (constant-speed control) by using the PID control so that the motor rotates in the target rotation number (Step 89). Then, the process is returned to Step 86.

As described above, in this embodiment, the target rotation number is calculated based on the velocity mode and the power supply voltage, and the constant-speed control is performed to accomplish the target rotation number. As a result, the velocity modes can be appropriately converted, even though the battery voltage varies.

### Embodiment 2

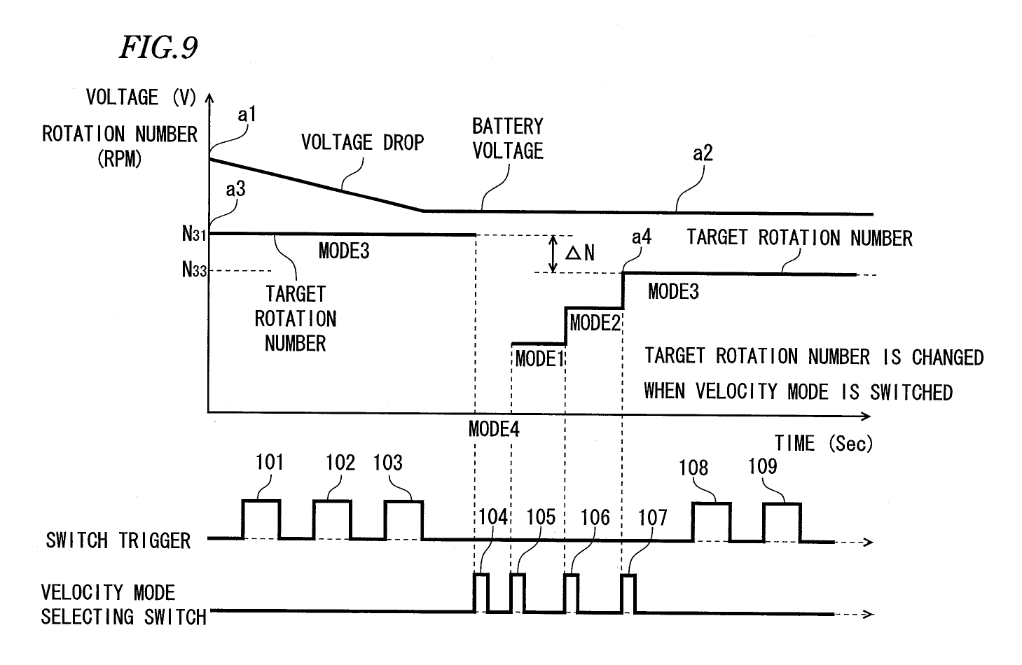

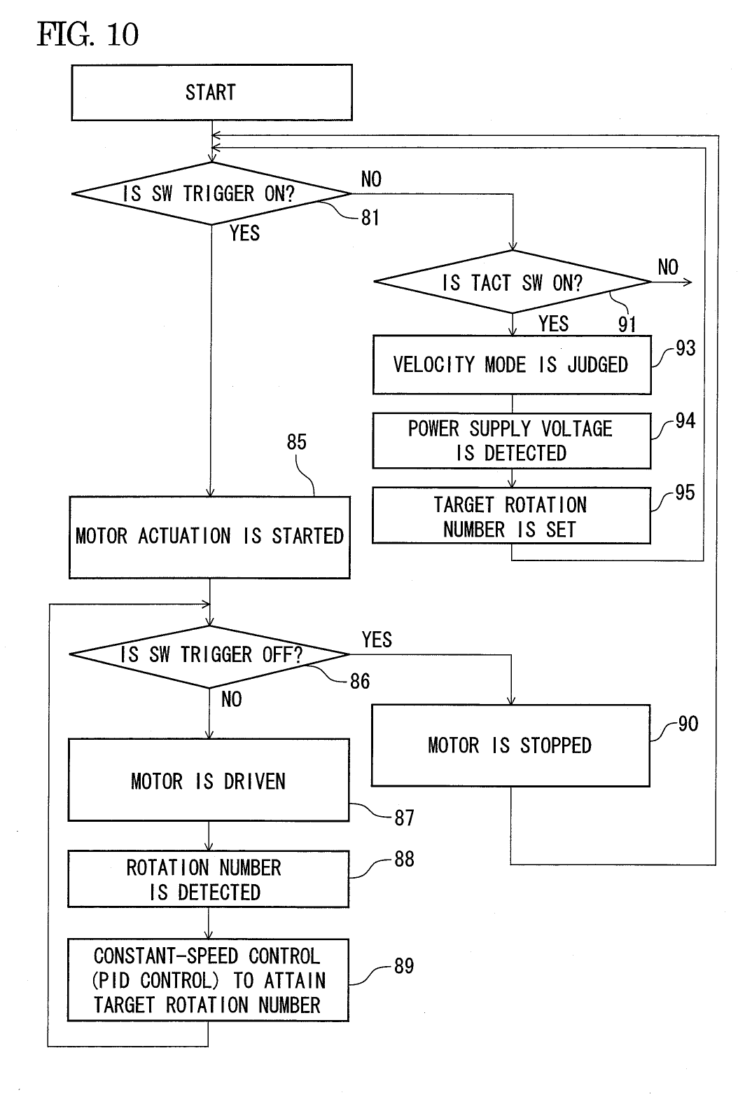

Referring to FIGS. 9 and 10, a control process flow for the motor in a second embodiment will be described. In the first embodiment, the target rotation number based on the power supply voltage is set every time the switch trigger 7 is pulled. On the other hand, in the second embodiment, the target speed is reset, by measuring the power supply voltage when the velocity mode selecting switch 42 is switched, without performing frequent changes of the target rotation number. The controlling state is shown in FIG. 9. In FIG. 9, a Y-axis represents the power supply voltage (the voltage of the battery pack 30) and the target rotation number (rpm) of the motor 2, and an X-axis represents the time (sec). In a lower part of FIG. 9, operation state of the switch trigger 7 (an output of the switch operation detecting circuit 40) and output signals of the velocity mode selecting switch 42 are also shown correspondingly.

In FIG. 9, in case where plural works are performed by pulling the switch trigger 7, the battery voltage is gradually decreased due to a voltage drop. In this drawing, the target rotation number is set to Mode 3, and three works 101, 102, and 103 are performed, and thereafter, the velocity mode selecting switch is operated, and two works 108, 109 are further performed. In this case, it is presumed that after the work 103, the user operates the velocity mode selecting switch 42 to convert the mode from Mode 3 to Mode 4, Mode 1, Mode 2, and again to Mode 3. The velocity mode selecting switch 42 in this embodiment is realized as a toggle switch, and so, pulse signals 104 to 107 are transmitted to the operational part 32 every time the button is pressed. The operational part 32 converts the velocity mode according to the pulse signals 104 to 107, and changes the target rotation number. On occasion of setting the velocity modes 1, 2, 3, the voltage of the battery pack 30 is measured, and the target rotation number corresponding to the voltage is set, based on the relation as shown in FIG. 6. Therefore, as compared with the target rotation number a3 corresponding to a time point of an arrow mark a1 when the battery voltage is high, the target rotation number a4 which is set at a time point of an arrow mark a2 when the battery voltage drops is lowered by a difference ΔN (=N31−N33). As described above, in this embodiment, the target rotation number can be changed according to the battery voltage, when the velocity mode is converted.

Then, referring to FIG. 10, a control process flow for the motor in the second embodiment will be described. In FIG. 10, the same control steps as in FIG. 8 are denoted with the same reference numerals. As a first step, whether or not the switch trigger 7 is turned on is judged in Step 81. In case where the switch trigger 7 is kept off, whether or not a tact switch (one of control buttons of the driver drill, not shown) is turned on is judged (Step 91). In case where the tact switch is turned on, the velocity mode which is stored in an operational part of the tact switch is read out (Step 93). In case where the tact switch is not turned on, the process is returned to Step 81 (Step 91).

Then, receiving an output of the voltage detecting circuit 37, the operational part 32 detects the voltage of the battery pack 30 (Step 94). The target rotation number is set from the relation in FIG. 6, based on the detected voltage and the judged velocity mode (Step 95), and the process is returned to Step 81. When the switch trigger 7 is turned on in Step 81, the operational part 32 actuates the motor 2, and accelerates the rotation of the motor 2 up to the preset target rotation number. The succeeding controls in Steps 86 to 90 are the same as Steps 86 to 90 in FIG. 8.

As described above, according to the control in the second embodiment, the target rotation number is calculated based on the velocity mode and the power supply voltage.

Therefore, the velocity modes can be converted, even though the battery voltage is varied, by making the target rotation number changeable according to variation of the battery voltage. Moreover, the target rotation number is changed only when the velocity mode is converted, it is always possible to constantly control the rotation number, unless the velocity mode is converted. If the target rotation number is changed every time the motor is actuated, the rotation number is influenced by variation of the battery voltage, and there is such possibility that the rotation number may be varied by every one operation.

### Embodiment 3

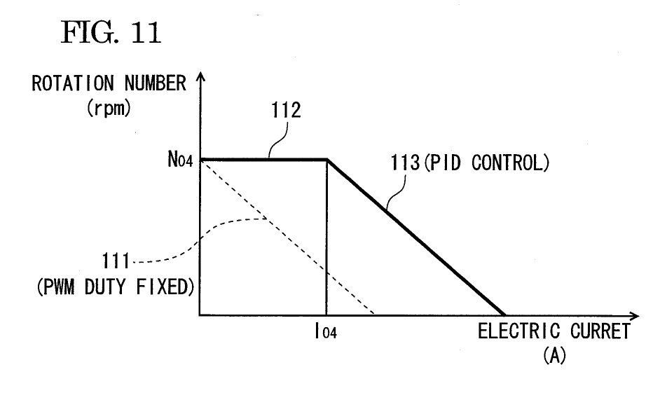

Then, referring to FIGS. 11 to 13, a third embodiment will be described. FIG. 11 illustrates relation between the target rotation number of the motor and the output torque. In the comparison-example method for controlling the rotation of the motor with the PWM duty fixed, when the electric current flowing to the motor is increased due to an increase of load such as a repulsive force from the tip tool, the rotation number of the motor is decreased in inverse proportion to the current, as indicated by a dotted line 111. On the other hand, in a constant-speed control method employing the PID control as indicated n by a solid line 113, for the purpose of rotating the motor at the target speed, the control of the input value is performed by feeding back using three elements including a deviation between the output value and the target value, and an integral and a differential thereof. By using the PID control in this manner, the rotation number of the motor is kept constant, until the electric current of the motor reaches a certain current 104, as a flat part indicated by an arrow mark 112.

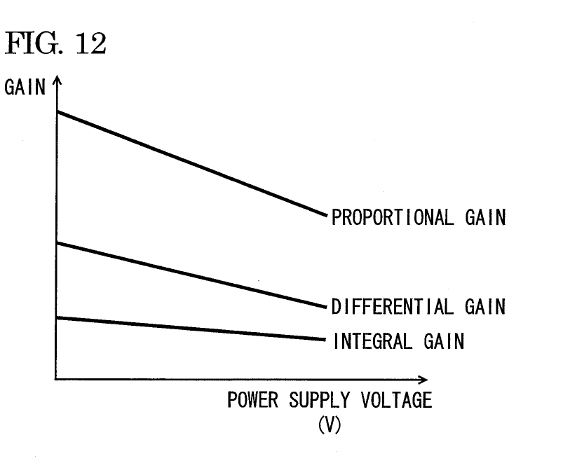

Then, referring to FIG. 12, a deviation (proportion) gain, an integral gain, and a differential gain in the PID control relative to the power supply voltage will be described. In this embodiment, the PWM duty is controlled by the PID control for performing the constant-speed control, a control gain of the PID control is switched in association with the voltage. A state of this association is shown in FIG. 12. By making the respective control gains variable according to the battery voltage in this manner, it is possible to enhance controlling performance of the PID control.

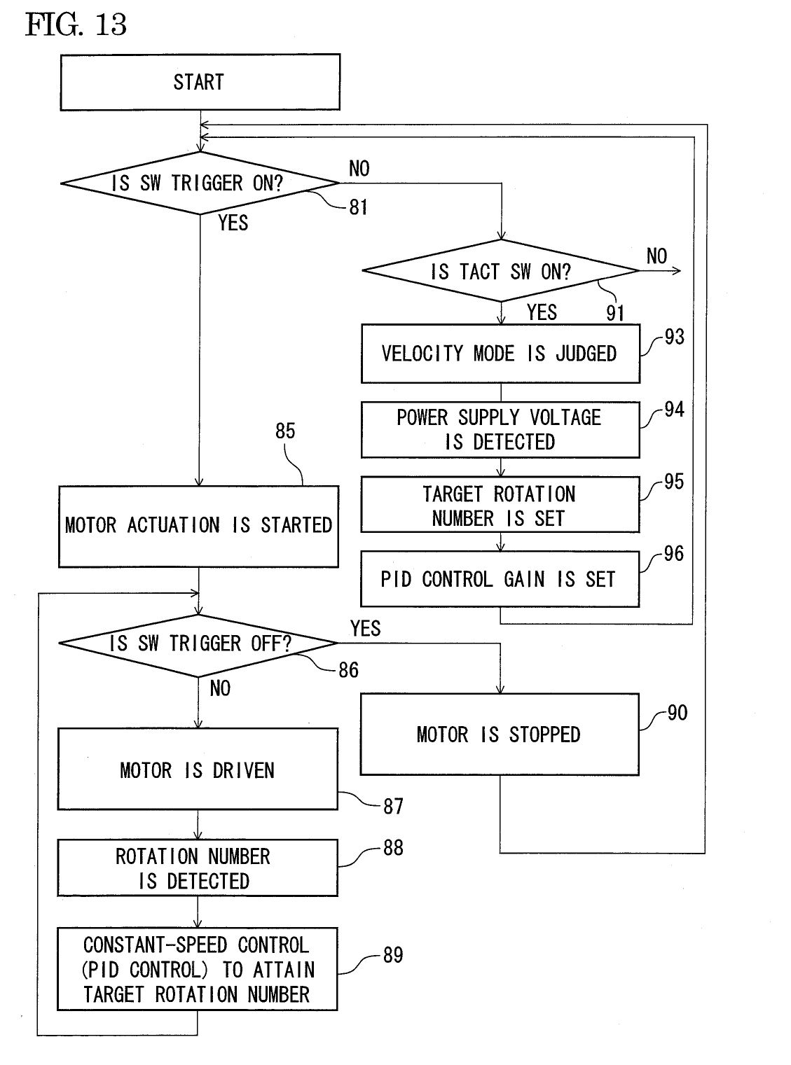

Then, referring to FIG. 13, a control process flow for the motor in the third embodiment will be described. In FIG. 13, the steps are substantially the same as in FIG. 10, and the same steps are denoted with the same reference numerals. This embodiment is different from the second embodiment in that Step 96 is added, and the control gain of the PID control is switched according to the power supply voltage, after the target rotation number corresponding to the power supply voltage is set in Step 95. In order to set this control gain, the relation as shown in FIG. 12 may be stored beforehand in a form of a formula or a data table in the memory.

According to the third embodiment as described above, the control gain is switched in association with the voltage, controlling performance of the PID control can be enhanced as well as in the second embodiment.

Although the embodiments are described, the invention is not limited to the above described embodiments, but various modifications can be made within a scope of the invention. For example, although the brushless DC motor is exemplified as the motor in the embodiments, it other types of motors to be controlled by a microcomputer or the like, after the target rotation number is set may be used.

This application claims priority from Japanese Patent Application No. 2009-163941 filed on Jul. 10, 2009, the entire contents of which are incorporated herein by reference.

### INDUSTRIAL APPLICABILITY

According to the invention, there is provided a power tool in which a motor can be stably rotated according to a preset target rotation number.

1. A power tool comprising:
a motor;
a driving circuit that supplies an electric power from a power supply to the motor;
a control part that sets a target rotation number for the motor in accordance with a mode selected from a plurality of modes, each mode having a corresponding target rotation number; and
a voltage detecting circuit that detects a voltage of the power supply,
wherein the target rotation number is varied based on the detected voltage.

2. The power tool of claim 1, further comprising:
a switch trigger to activate the motor,
wherein the control part measures the voltage after the switch trigger is turned on and before the motor starts to rotate, and sets the target rotation number based on the measured voltage.

3. The power tool of claim 1, further comprising:
a selecting switch to select between the plurality of modes,
wherein the control part measures the voltage when the mode is changed by the selecting switch.

4. The power tool of claim 1,
wherein the target rotation number is set to be proportional to the voltage of the power supply.

5. The power tool of claim 1,
wherein the driving circuit is an inverter circuit including a semiconductor switching element, and
wherein the control part controls a PWM duty which is supplied to the inverter circuit, thereby to control the rotation of the motor.

6. The power tool of claim 5,
wherein the control part controls the PWM duty by performing a PID control, thereby to bring the rotation number of the motor to the target rotation number.

7. The power tool of claim 6,
wherein the control part changes a gain of the PID control based on the measured voltage.

8. The power tool of claim 7,
wherein the gain is increased or decreased in proportion to the voltage of the power supply.

9. The power tool of claim 1,
wherein the motor is a brushless DC motor.
